(19) United States
(12) Patent Application Publication
(10) Pub. No.: US 2004/0093576 A1
(43) Pub. Date: May 13, 2004

(54) Semiconductor device, design method for semiconductor device, design apparatus and design program for semiconductor device

(75) Inventors: Etsuko Terasawa, Okaya-shi (JP); Yoshiteru Ono, Chine-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 10/632,104

(22) Filed: Jul. 30, 2003

(30) Foreign Application Priority Data
Jul. 30, 2002 (JP) 2002-221261

(51) Int. Cl. G06F 17/50

(52) U.S. Cl. 716/10; 716/7; 716/8

(57) ABSTRACT

A method for designing a semiconductor device includes receiving a net list of a semiconductor device, temporarily locating a plurality of functional blocks within a layout area of the semiconductor device and dividing a logic area of the semiconductor device into a plurality of rectangular areas and computing a predicted value of a utilization rate of the logic area and a predicted value of a wiring length of the semiconductor device based on a data base regarding a semiconductor device designed previously and the semiconductor device and the net list of the semiconductor device. The method also includes locating, dividing and computing when the predicted value of the utilization rate of the logic area of the semiconductor device does not satisfy a predetermined condition, outputting floor plan information for allocating the plurality of functional blocks basic cells and wiring within the logic area of the semiconductor device when the predicted value of the utilization rate of the logic area satisfies the predetermined condition and outputting the predicted value of the wiring length of the semiconductor device.

### BACKGROUND OF THE INVENTION

1. Technical Field of the Invention

The present invention relates to a method of designing a semiconductor device and a semiconductor device designed by such a method. More particularly, the present invention relates to an apparatus for designing a semiconductor device using a method of designing a semiconductor device and a program for designing a semiconductor device.

2. Description of Related Art

Conventionally, in designing a semiconductor device, an apparatus for designing a floor plan is used for creating the floor plan. Here, a floor plan means determining the approximate location for a functional block, a basic cell, aluminum wiring and components of a semiconductor device.

In a semiconductor device, there is an area, which is referred to as a logic area. The logic area is any area except the area where an I/O area and the functional block are located. In this logic area, a plurality of basic cells and wiring connecting basic cells to each other, wiring connecting basic cells to functional blocks and wiring connecting functional blocks to each other are arranged. In designing a semiconductor device using the above-mentioned conventional floor plan apparatus, functional blocks are arranged in the first stage, then wiring connecting basic cells to each other, wiring connecting basic cells to functional blocks and wiring connecting functional blocks to each other are arranged.

By the way, in designing a semiconductor device, there is a case when the utilization rate of a logic area is used. The utilization rate of a logic area is expressed as:

Utilization rate of a logic area=The total area of basic cells arranged in a logic area/an area of a logic area Equation 1

Hence, the utilization rate of a logic area is determined after completing arrangement of the basic cells within a logic cell.

In addition, it is known that, even if the size of the gates of the semiconductor device (the total number of gates) is the same, but the configuration of a logic area is different, the utilization rate of the logic area is different. On the other hand, the configuration of the logic area varies depending on the arrangement of the functional blocks.

When the utilization rate of the logic area of the semiconductor device is greater than or equal to a predetermined value, a space for allocating aluminum wiring, in the logic area of the semiconductor device shrinks. In addition, connecting basic cells to each other increases and a rate of aluminum wiring for connecting basic cells also increases. Therefore, it is difficult to arrange aluminium wiring within the logic area of the semiconductor device. Therefore, if the utilization rate of the logic area is clarified at the beginning stage of the floor plan of the semiconductor device, the time for designing the semiconductor device can be shortened. In addition, if a predicted value of the wiring length can be computed with a high degree of accuracy at the beginning stage of the floor plan of the semiconductor device, efficiency of designing the semiconductor device can be improved.

However, as above-mentioned, the utilization rate of a logic area is completed after the basic cells within the logic area have been arranged. Therefore, in the above-mentioned conventional floor plan apparatus, the utilization rate of the logic area of the semiconductor device had not been considered.

A conventional method for designing the semiconductor device discloses determining approximate arrangements of locating blocks, which realize each of the functions included in the semiconductor integrated circuit apparatus and cells located within these blocks by a initial floor plan. The method also includes determining an area and configurations of these blocks estimated and displayed based on this initial floor plan. This displayed arranged location and configurations of these blocks can be corrected by a conversational approach, when the semiconductor integrated circuit device is designed by a standard cell method or a building block method using a gate array method. However, this conventional method for designing a semiconductor integrated circuit device does not design a floor plan by using the utilization rate of the logic area.

A conventional logic synthesis apparatus that produces a logic net list by implementing an area optimization process to a logic synthesis result of inputted function description language includes a means for computing a wiring area, which computes a wiring area of signal lines in the logic synthesis result where area optimization process is implemented and a means for computing a gate area, which computes a usable gate area based on a desirable lay out area designated by outside and the computed result of the means for computing a wiring area. The apparatus also includes a means for judging optimization that judges whether the area optimization process to a logic synthesis results is necessary or not from the result computed by the means for computing a gate area and the gate area of the logic synthesis result.

However, the logic synthesis apparatus disclosed implements optimization for a layout size desired by a designer whereas it does not design a floor plan by the using utilization rate of the logic area.

Also, a conventional method of estimating a wiring length that estimates a wiring length of an objected LSI from a net list, which describes connecting information of a LSI and a cell library storing information of cells used for a LSL design in order to design a layout of a LSI, includes a process for estimating the initial wiring length of the objected LSI based on each basic wiring length determined from a half circumference length of a square having a area equivalent to the value obtained by multiplying average area of cells of net of each fan out numbers with numbers of cells per one piece and based on information extracted from a net list and a cell library. The method also includes a process for estimating an area where wiring on a layout of an objected LSI is available from the total cell area, by obtaining the total cell area of the objected LSI based on information extracted from the cell library. The method further includes a process for estimating a layout area of an objected LSI by obtaining a wiring area where the wiring occupies on an objected LSI from the initial wiring length and adopting area obtained by adding the difference between the wiring area and the available wiring area to the total cell area when the wiring area is larger than the available wiring area; and a process of correcting the initial wiring length according to the increase from the total cell area to the layout area in order to determine the total wiring length of an objected LSI.

However, this method of estimating a wiring length estimates the wiring length, but does not estimate the wiring length by using a regression formula and does not design a floor plan by using the utilization rate of the logic area.

Thus, in view of the above-mentioned points, a first aspect of the present invention is to provide a method of designing a semiconductor device for calculating a predicted value of a wiring length and a predicted value of the utilization rate of a logic area of the semiconductor and designing a semiconductor device by using the predicted value of the wiring length and predicted value of the utilization rate of the logic area of the semiconductor. In addition, a second aspect of the present invention is to provide a semiconductor device designed by such a method of designing a semiconductor device. In addition, a third aspect of the present invention is to provide an apparatus for designing a semiconductor device by using such a method of designing the semiconductor device. In addition, a fourth aspect of the present invention is to provide a program for designing the semiconductor device.

### SUMMARY OF THE INVENTION

In order to overcome the above-mentioned problems, a method of designing a semiconductor device related to the present invention includes receiving a net list of a semiconductor device, temporarily locating a plurality of functional blocks within a layout area of the semiconductor device and dividing a logic area of the semiconductor device into a plurality of rectangular areas. The method also includes computing a predicted value of a utilization rate of the logic area and the predicted value of a wiring length of the semiconductor device based on a data base regarding a semiconductor device designed previously and a semiconductor device and the net list of the semiconductor device and repeating the locating, dividing and computing steps when the predicted value of the utilization rate of the logic area of the semiconductor device does not satisfy a predetermined condition. The method further includes outputting floor plan information for allocating the plurality of functional blocks, basic cells and wiring within the logic area of the semiconductor device when the predicted value of the utilization rate of the logic area satisfies the predetermined condition and outputting the predicted value of the wiring length of the semiconductor device.

Further, in order to overcome the above-mentioned problem, a semiconductor related to the present invention is designed by the method of designing a semiconductor device related to the present invention.

Further, in order to overcome the above-mentioned problem, an apparatus for designing a semiconductor device includes an input unit that inputs the net list of a semiconductor device and information that designates arranged locations of a plurality of functional blocks, which are located within the semiconductor device; a first recorder that records the net list of the semiconductor device; a second recorder that records a data base with respect to a semiconductor device designed previously and the semiconductor device; and a third recorder that records information with respect to a basic cell located within the semiconductor device designed previously and a basic cell possibly located in the logic area of the semiconductor device.

The apparatus also includes a unit that temporarily arranges the plurality of functional blocks, which temporarily arranges the plurality of functional blocks within a layout region of the semiconductor device in response to information designating the arranged location; a unit that divides the logic area of the semiconductor device into a plurality of rectangular areas; a unit that computes a predicted value of a utilization rate of the logic area, which computes a predicted value of a wiring length and the predicted value of the utilization rate of the logic area of the semiconductor device based on the data base and the net list of the semiconductor device; and a unit that judges the predicted value of the utilization rate of the logic area, which judges whether the predicted value of the utilization rate of the logic area in the semiconductor device satisfies a predetermined condition or not, and promoting a user to input information designating a new arranged location for the plurality of functional blocks located within the semiconductor device when the predicted value of the utilization rate of the logic area does not satisfies the predetermined condition. The apparatus further includes a unit that outputs floor plan information, which outputs floor plan information for arranging the plurality of functional blocks, basic cells, and wiring within the logic area of the semiconductor device or arranges the plurality of functional blocks, basic cells, and wiring when the predicted value of the utilization rate of the logic area satisfies the predetermined condition; a unit that outputs the predicted value of the wiring length, which outputs the predicted value of the wiring length of a semiconductor device; and a display that displays the layout of the semiconductor device where the plurality of functional blocks is temporarily arranged by the unit that temporarily arranges the plurality of functional blocks; an image for promoting the user to input information designating the new arranged location for the plurality of functional blocks located within the semiconductor device when the predicted value of the utilization rate of the logic area does not satisfy a predetermined condition; and/or the layout of the semiconductor device where the plurality of functional blocks, basic cells, and wiring are arranged by the unit that outputs floor plan information.

In order to overcome the above-mentioned problems, a program of designing a semiconductor device, makes a CPU execute a step (a) receiving a net list of a semiconductor device; a step (b) temporarily locating a plurality of functional blocks within a layout area of a semiconductor device; a step (c) dividing a logic area of the semiconductor device into a plurality of rectangular areas; and a step (d) computing a predicted value of a utilization rate of the logic area and a predicted value of a wiring length of the semiconductor device based on a data base regarding a semiconductor device designed previously and the semiconductor device and the net list of the semiconductor device. The CPU also executes a step (e) repeating the step (b) to the step (d) when the predicted value of the utilization rate of the logic area does not satisfy a predetermined condition; a step (f) outputting floor plan information for allocating the plurality of functional blocks, basic cells and wiring within the logic area of the semiconductor device when the predicted value of the utilization rate of the logic area satisfies the predetermined condition; and a step (g) outputting the predicted value of the wiring length of a semiconductor device.

According to the above-mentioned structure, time for designing a semiconductor device can be shortened.

### BRIEF DESCRIPTION OF DRAWINGS

FIG. 1 is a diagram showing an apparatus for design a floor plan of a semiconductor device related to one of embodiments of the present invention.

FIG. 2 is a diagram showing one example of a semiconductor device where a floor plan was designed.

FIG. 3 is a diagram showing the situation where a logic area of FIG. 1 is divided into plural rectangular areas.

FIG. 4 is a diagram showing one example of a net connected to two pins.

FIG. 5 is a diagram showing one example of a net connected to three pins.

FIG. 6 is a diagram showing one example of a net connected to four pins.

FIG. 7 is a diagram showing an example of a graph where the number of connection pins is along the abscissa and a ratio of the number of accumulated nets to the number of all nets is along the ordinate when all nets are arrayed from a net having the small number of connection pins to a net having the large number of connection pins and accumulated from a net having the small number of connection pins.

FIG. 8 is a diagram showing an example of a graph where the number of connection pins is along the abscissa and an average value of wiring lengths of nets computed every number of connection pins after classifying all nets into the number of connection pins is along the ordinate.

FIG. 9 is a diagram showing an internal configuration of the unit for computing a predicted value of a utilization rate of a logic area 7.

FIG. 10 is a flow chart showing operation of an apparatus for designing a floor plan of a semiconductor device.

FIG. 11 is a flow chart showing operation of an apparatus for designing a floor plan of a semiconductor device.

### DETAILED DESCRIPTION OF THE PREFERRED EMBODIMENTS

The preferred embodiment of the present invention is described hereafter referring to drawings. In addition, it should be noted that components that are the same have been assigned the same reference numerals.

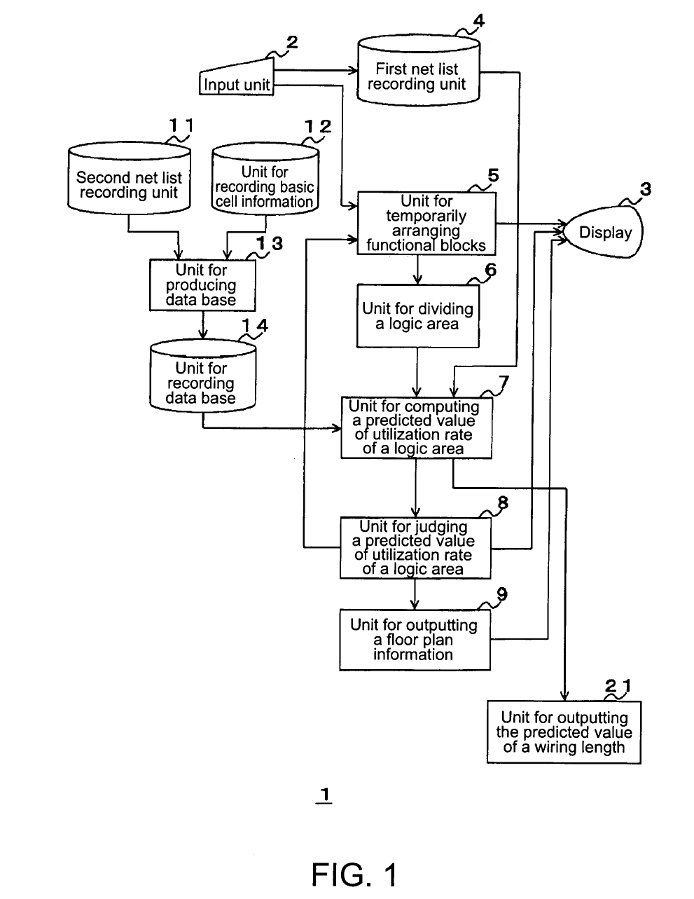

FIG. 1 shows an apparatus for designing a floor plan of a semiconductor device regarding one embodiment of the present invention. In FIG. 1, an apparatus 1 includes an input unit 2, a display 3, a first net list recording unit 4, a unit for temporarily arranging functional blocks 5, a unit for dividing a logic area 6 and a unit for computing a predicted value of a utilization rate of a logic area 7. Apparatus 1 also includes a unit for judging a predicted value of the utilization rate of a logic area 8, a unit for outputting a floor plan information 9, a second net list recording unit 11, a unit for recording basic cell information 12, a unit for producing a data base 13, a unit for recording a data base 14 and a unit for outputting a predicted value of a wiring length 21.

The input unit 2 is a keyboard, a mouse or other device, for inputting a net list of a semiconductor device and instructing temporary arrangement of functional blocks, which should be stored in a semiconductor device. The display 3 is a CRT, a LCD for displaying letters, pictorial images and others.

The first net list recording unit 4 receives a net list of the semiconductor device from the input unit 2. The unit for temporarily arranging functional blocks 5, temporarily arranges functional blocks, which should be stored in the semiconductor device in response to an arrangement instruction by a user.

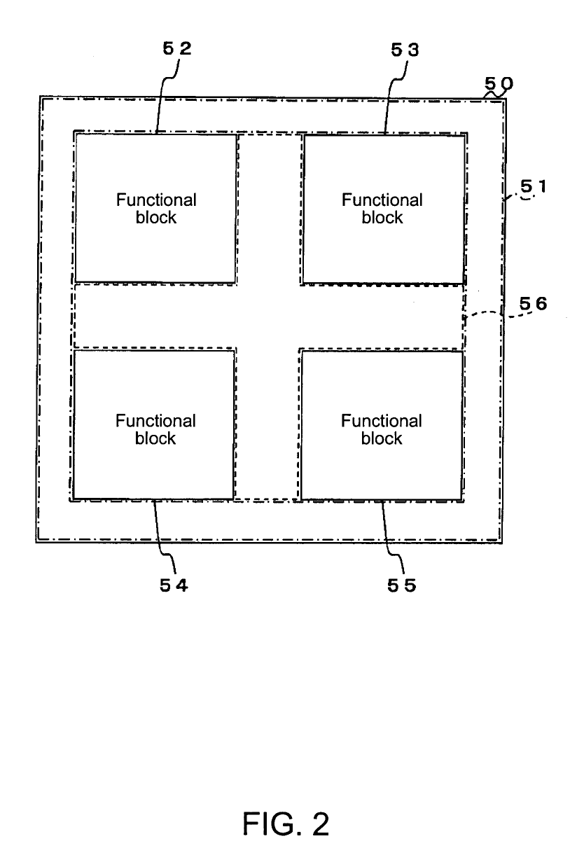

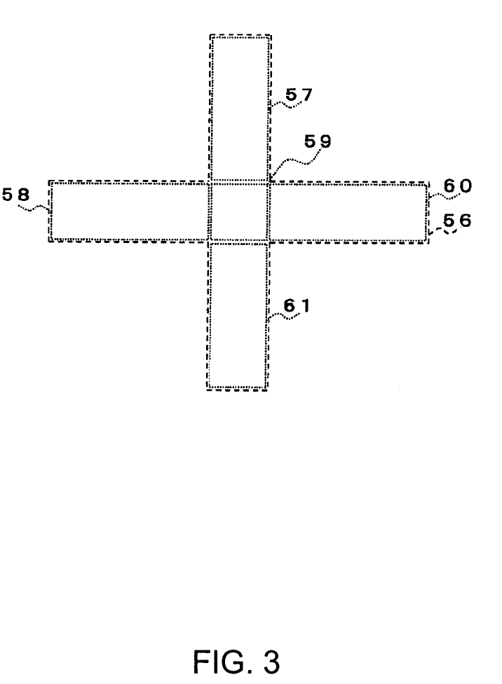

The unit for dividing a logic area 6 divides a logic area into a plurality of rectangular areas, when configuration of the logic area of the semiconductor device is not a rectangle. FIG. 2 and FIG. 3 are diagrams showing an example of dividing the logic area into units for dividing a logic area 6. As shown in FIG. 2, in the peripheral region of the semiconductor device 50, there is a circular input/output area 51 for arranging an input/output buffer, an input/output pad and others and four functional blocks 52 to 55 are temporarily arranged in an area surrounded by this input/output area 51. This logic area 56 of the semiconductor device 50 has a cross-shaped geometry. In this case, the unit for dividing the logic area 6 divides the logic area 56 into five rectangular areas 57 to 61 as shown in FIG. 3. In these rectangular areas 57 to 61, a plurality of basic cells and a plurality of aluminum wirings are arranged.

According to FIG. 1, the second net list recording unit 11 records a net list of a semiconductor device designed in the past.

The unit for recording basic cell information 12 records data regarding basic cells arranged within the logic area of the semiconductor device designed in the past and data regarding basic cells to probably be arranged within a logic area of a semiconductor device.

The unit for producing data base 13 produces a database by using a net list of the semiconductor device designed in the past, data regarding basic cells arranged within the logic area of the semiconductor device designed in the past and data regarding basic cells to probably be arranged within the logic area of the semiconductor device. The database produced by the unit for producing data base 13 includes (i) information regarding basic cells arranged within the logic area of the semiconductor device designed in the past, (ii) information regarding the net list of the semiconductor device designed in the past, (iii) information regarding the wiring length of the semiconductor device designed in the past, (iv) information regarding the utilization rate of the logic area of the semiconductor device designed in the past and (v) information regarding basic cells to probably be arranged within the logic area of the semiconductor device.

The above-mentioned (i) information regarding basic cells arranged within the logic area of the semiconductor device designed in the past, includes (a) a rate of the number of pins per one piece of basic cell (b) a rate of the number of nets per one piece of basic cell (c) information regarding the kind of basic cells (for example, lots of flip flops, lots of complex gates, an amount of upper wirings of aluminum wiring layers and an amount of null grids).

The above-mentioned, (ii) information regarding a net list of the semiconductor device designed in the past, includes (d) the size of the gates (the total number of gates), the number of nets and the number of used basic cells, (e) the number of connected pins (referred to as the number of connection pins hereafter) where a ratio of the number of accumulated nets to the number of all nets surpasses a predetermined value (for example, 90%, 80%, 70% and others) when all nets are arrayed from a net having a small number of connection pins to a net having a large number of connection pins and accumulated from a net having a small number of connection pins, (f) a ratio of the number of nets having the number of connection pins, two “2” to the number of all nets, (g) a gradient of a straight line connecting the point of the number of connection pins, two “2” to the point of the number of connection pins where a ratio of the number of accumulated nets to the number of all nets surpasses a predetermined value, in a graph where the number of connection pins is along the abscissa and a ratio of the number of accumulated nets to the number of all nets is along the ordinate when all nets are arrayed from a net having the small number of connection pins to a net having a large number of connection pins and accumulated from a net having a small number of connection pins, and (h) a ratio of the number of connection pins.

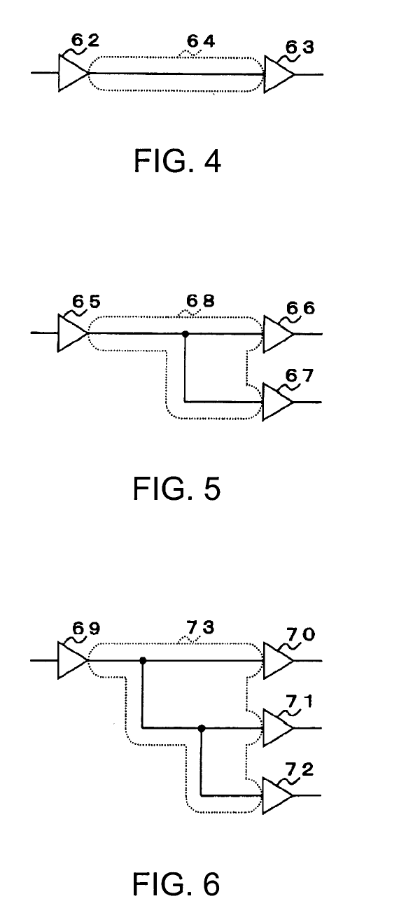

The number of connection pins of a net is described referring to FIG. 4 to FIG. 6. As shown in FIG. 4, the number of connection pins of a net 64 connected to two pieces of pins, the output pin of a basic cell 62 and the input pin of a basic cell 63, is two “2”. In addition, as shown in FIG. 5, the number of connection pins of a net 68 connected to three pieces of pins, the output pin of a basic cell 65 and the input pins of a basic cell 66 and 67, is three “3”. Furthermore, as shown in FIG. 6, the number of connection pins of a net 73 connected to four pieces of pins, the output pin of a basic cell 69 and the input pins of a basic cell 70 to 72, is four “4”. Hence, the number of connection pins of a net connected to “n” pieces of pins,(“n” is an integer equal to or more than 2) is “n”.

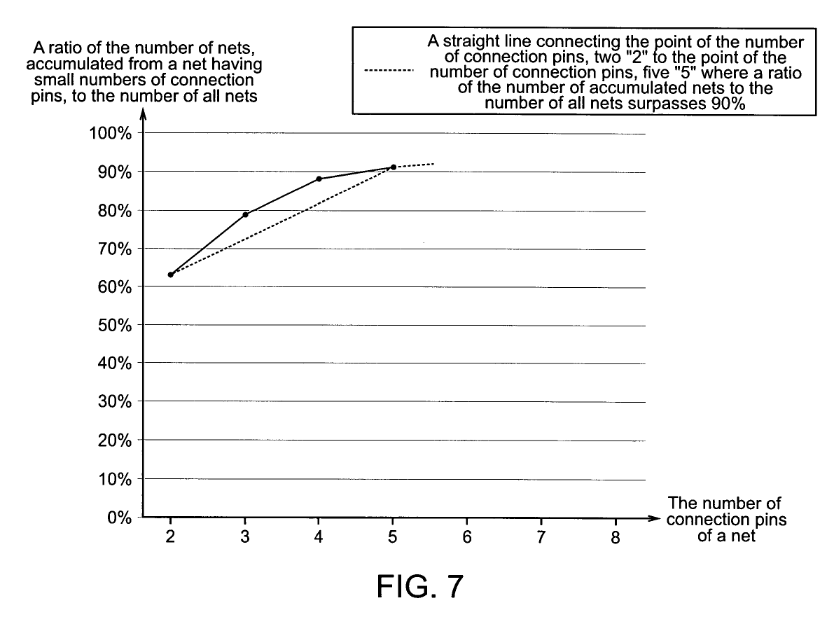

Next, the above-mentioned (e) number of connection pins where a ratio of the number of accumulated nets to the number of all nets surpasses a predetermined value, when all nets are arrayed from a net having a small number of connection pins to a net having a large number of connection pins and accumulated from a net having a small number of connection pins, is described referring to FIG. 7. FIG. 7 is an example of a graph where the number of connection pins is along the abscissa and a ratio of the number of accumulated nets to the number of all nets is along the ordinate when all nets are arrayed from a net having a small number of connection pins to a net having a large number of connection pins and accumulated from a net having a small number of connection pins.

As shown in FIG. 7 the ratio of the number of nets of which the number of connection pins is two “2” to the number of all nets is around 63%. In addition, the ratio of the number of nets of which the number of connection pins is two “2” or three “3” to the number of all nets is around 79%. In addition, the ratio of the number of nets of which the number of connection pins is two “2”, three “3” or four “4” to the number of all nets is around 88%. In addition, the ratio of the number of nets of, which the number of connection pins is two “2”, three “3”, four “4” or five “5” to the number of all nets is around 92%.

In the graph shown in FIG. 7, the number of connection pins where a ratio of the number of accumulated nets to the number of all nets surpasses a predetermined value (90% here), when all nets are arrayed from a net having a small number of connection pins to a net having a large number of connection pins and accumulated from a net having a small number of connection pins, is five “5”.

Next, the above-mentioned (g) gradient of a straight line connecting the point of the number of connection pins, two “2” to the point of the number of connection pins where a ratio of the number of accumulated nets to the number of all nets surpasses a predetermined value, in a graph where the number of connection pins is along the abscissa and a ratio of the number of accumulated nets to the number of all nets is along the ordinate when all nets are arrayed from a net having a small number of connection pins to a net having a large number of connection pins and accumulated from a net having a small number of connection pins, is described referring to FIG. 7.

As shown in FIG. 7, the number of connection pins where a ratio of the number of accumulated nets to the number of all nets surpasses a predetermined value (90% here), when nets are accumulated from a net having a small number of connection pins, is five “5”. In FIG. 7, the above-mentioned (g) gradient of a straight line connecting the point of the number of connection pins, two “2” to the point of the number of connection pins where a ratio of the number of accumulated nets to the number of all nets surpasses a predetermined value, in a graph where the number of connection pins is along the abscissa and a ratio of the number of accumulated nets to the number of all nets is along the ordinate when all nets are arrayed from a net having a small number of connection pins to a net having a large number of connection pins and accumulated from a net having a small number of connection pins, is a gradient of a thick dot line connecting the point of the number of connection pins, two “2” to the point of the number of connection pins, five “5”. In addition, in stead of using a thick dot line connecting the point of the number of connection pins, two “2” to the point of the number of connection pins, five “5”, a gradient of an approximate straight line formed with the point of the number of connection pins, two “2”, the point of the number of connection pins, three “3”, the point of the number of connection pins, four “4”, or the point of the number of connection pins, five “5”, may be used.

Further, the above-mentioned (iii) information regarding a wiring length of the semiconductor device designed in the past, includes (h)) an average value of wiring lengths of all nets according to each of the number of layers of usable wiring layers, (i)) a gradient of a graph where the number of connection pins is along the abscissa and an average value of wiring lengths of nets for every number of connection pins is along the ordinate, (j), an average value of wiring lengths of nets of which the number of connection pins is two “2”.

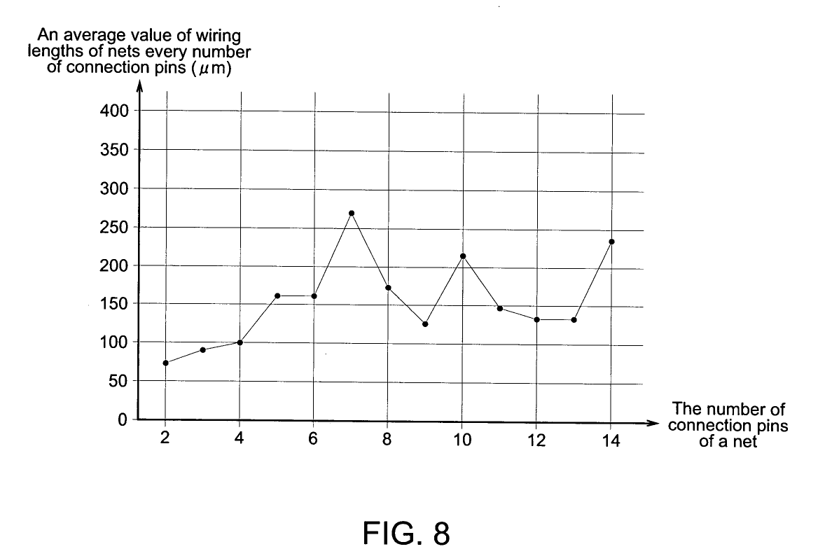

Next, the above-mentioned (i) a gradient of a graph where the number of connection pins is along the abscissa and an average value of wiring lengths of nets computed for every number of connection pins after classifying all nets into the number of connection pins is along the ordinate, is described referring to FIG. 8. FIG. 8 is a diagram showing an example of a graph where the number of connection pins is along the abscissa and an average value of wiring lengths of nets computed for every number of connection pins after classifying all nets into the number of connection pins is along the ordinate. Here, in order to improve the accuracy of a gradient, this is an example where a gradient until the number of connection pins occupying 90% of all nets is obtained. When the semiconductor device is the semiconductor device where the number of nets of which connection pins is two “2” to seven “7” occupies 90% of the number of all nets, a gradient of connecting the point of the number of connection pins, two “2” to the point of the number of connection pins, seven “7” is used.

In addition, an average value of wiring lengths of nets for every number of connection pins may be an average value of wiring lengths of all nets for every number of connection pins, or only nets having wiring lengths which are under a predetermined wiring length regulated for every number of connection pins may be extracted and an average value of wiring lengths of these nets may be employed as the above average value. In addition, an average value of the wiring lengths of nets where a ratio of the number of accumulated nets to the number of all nets surpasses a predetermined value, (for example, 90%, 80%, 70%) when nets are arrayed from a net having a small number of connection pins to a net having a large number of connection pins and accumulated from a net having a small number of connection pins, may be employed as the above average value.

These are to improve accuracy of a predicted value of a utilization rate of the logic area of the semiconductor device with reducing affects of nets having long wiring lengths.

Similarly, the above-mentioned (j) average value of wiring lengths of nets of which the number of connection pins is two “2” may be an average value of the wiring lengths of nets obtained by extracting nets having wiring lengths, which are under a predetermined wiring length, among nets of which the number of connection pins is two “2”. In addition, an average value of wiring lengths of nets where a ratio of the number of accumulated nets to the number of all nets, which number of connection pins is two “2”, surpasses a predetermined value, (for example, 90%, 80%, 70%) when nets of, which number of connection pins is two “2”, are arrayed from a net having a small number of connection pins to a net having a large number of connection pins and accumulated from a net having a small number of connection pins, may be employed as the above average value.

In addition, (iv) information regarding the utilization rate of the logic area of the semiconductor device designed in the past includes (k) the maximum value of a utilization rate when the number of layers of aluminum wiring layers is predetermined and the configuration of a logic area is square.

Referring to FIG. 1 again, the data base recording unit 14 records data base produced by the data base production unit 13.

The unit for computing a predicted value of a utilization rate of a logic area 7, uses the data base recorded by the data base recording unit 14 and a net list of the semiconductor device and computes a predicted value of wiring lengths and a predicted value of the utilization rate of the logic area, of the semiconductor device. The utilization rate of the logic area is confirmed after completing the design of the semiconductor. However, the unit for computing a predicted value of the utilization rate of the logic area 7, computes the predicted value of the utilization rate of the logic area of the semiconductor device at the time when functional blocks, which should be stored within the semiconductor device are temporarily arranged.

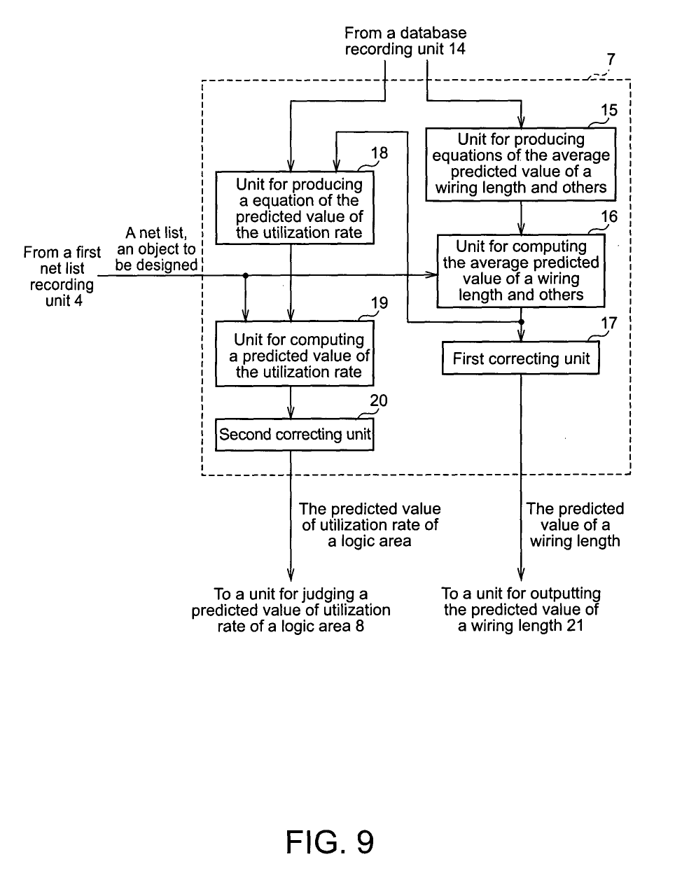

FIG. 9 is a diagram, which shows an internal configuration of the unit for computing a predicted value of the utilization rate of the logic area 7. As shown in FIG. 9, the unit for computing the predicted value of the utilization rate of the logic area 7 includes a unit for producing equations of the average predicted value of a wiring length and others 15, a unit for computing the average predicted value of a wiring length and others 16, a first correcting unit 17, a unit for producing an equation of the predicted value of the utilization rate 18, a unit for computing the predicted value of the utilization rate 19, and a second correcting unit 20.

The unit for producing equations of the predicted value of an average value of a wiring length and others 15, refers to the data base stored in the data base recording unit 14, and produces:

(m) an equation for computing the predicted value of an average value of a wiring length of the total nets for the semiconductor device in response to the number of layers of all usable wiring layer;

(n) an equation for computing the gradient in the graph where the number of connecting pins is along the abscissa and the predicted value of an average value of wiring lengths of nets for every number of connecting pins along the ordinate, in response to numbers of layers of all usable wiring layers; and

(o) an equation for computing the predicted value of an average value of the wiring length of the net of which the number of connecting pins within nets of the semiconductor device is two “2”, in response to number of layers of all usable wiring layers.

The unit for producing equations of the predicted value of an average value of a wiring length and others 15, produces the above-mentioned equations (m),(n) and (o), for example, by regression analysis.

The unit for computing the predicted value of an average value of a wiring length and others 16, uses the net list of the semiconductor device stored in the first net list recording unit 4 (see FIG. 1) and the above-mentioned equations (m) to (o) and computes:

(p) a predicted value of an average value of wiring lengths of all nets of the semiconductor in response to the number of all possible wiring layers;

(q) a gradient of a graph where the number of connecting pins is along the abscissa and an predicted value of an averaged value of wiring lengths of nets for every number of connecting pins along the ordinate in response to numbers of all possible wiring layers; and

(r) a predicted value of an averaged value of wiring lengths of nets of which the number of connecting pins, is two “2” in response to the numbers of all possible wiring layers.

The first correcting unit 17 corrects values of the above (p) to (r) computed by the unit for computing the predicted value of an average value of a wiring length and others 16. The logic area is divided into a plurality of rectangular areas (see. FIG. 1) by the unit for dividing the logic area 6 (see FIG. 1). However, rectangular areas produced by such dividing may be a configuration close to a square (for example, a rectangular area 59 in FIG. 3) or very long thin oblong (for example, rectangular areas 57, 58, 60 and 61 in FIG. 3). The first correcting unit 17 corrects values of the above (p) to (r) depending on such configuration of a rectangular area. The unit for outputting a predicted value of wiring lengths 21 (see FIG. 1) outputs the above-mentioned (0) predicted value (the value after correction) of an averaged value of wiring lengths of all nets of the semiconductor device in response to the number of all possible wiring layers, among the corrected values of (p) to ((r).

The unit for producing equations of the predicted value of the utilization rate 18, refers to the data base recorded in the data base recording unit 14, and produces equations for computing the predicted value of the utilization rate of the logic area of the semiconductor device by using the above-mentioned values of (p) to ((r) computed by the unit for computing the predicted value of an average value of a wiring length and others 16. The unit for producing equations of the predicted value of the utilization rate 18 produces an equation for computing the predicted value of the utilization rate of the logic area of the semiconductor device with regression analysis, for example.

The unit for computing the predicted value of the utilization rate 19, computes the predicted value of the utilization rate of the logic area of the semiconductor device by using the net list of the semiconductor device stored in the first net list recording unit 4 (see FIG. 1) and an equation for computing the predicted value of the utilization rate of the logic area of the semiconductor device produced by the unit for producing equations of the predicted value of the utilization rate 18.

The second correcting unit 20 corrects the predicted value of the utilization rate of the logic area of the semiconductor device computed by the unit for computing the predicted value of the utilization rate 19. The logic area is divided into a plurality of rectangular areas by the unit for dividing the logic area 6 (see FIG. 1). However, rectangular areas produced by such dividing may be a configuration close to a square (for example, a rectangular area 59 in FIG. 3) or very long thin oblong (for example, rectangular areas 57, 58 and 60 and 61 in FIG. 3). The second correcting unit 20 corrects the predicted value of the utilization rate of the logic area of the semiconductor device depending on such configuration of the rectangular area.

Referring to FIG. 1 again, the unit for judging the predicted value of the utilization rate of the logic area 8, judges whether the predicted value of the utilization rate of the logic area, computed by the unit for computing the predicted value of the utilization rate of the logic area 7, satisfies a predetermined condition or not. When the unit for judging the predicted value of the utilization rate of the logic area 8, judges that the predicted value of the utilization rate of the logic area of the semiconductor device satisfies a predetermined condition, the unit for outputting floor plan information 9 arranges a plurality of functional blocks and basic cells within the logic area in the semiconductor device and outputs floor plan information for arranging wiring connecting basic cells, wiring connecting a basic cell to a functional block and wiring connecting functional blocks within a logic area, or arranges a plurality of functional blocks, basic cells, and wiring.

The unit for outputting the predicted value of the wiring length 21 receives the predicted value of the wiring length of the semiconductor device from the unit for computing the predicted value of the utilization rate of the logic area 7, and outputs it to the outside.

A hard disk, a flexible disc, a MO, a MT, a RAM, a CD-ROM, a DVD-ROM and others function as the first net list recording unit 4, the second net list recording unit 11, the unit for recording a basic cell information 12 and the unit for recording data base 14, shown in FIG. 1. In addition, the unit for temporarily arranging functional blocks 5, the unit for dividing logic area 6, the unit for computing a predicted value of predicted value of the utilization rate of the logic area 7, the unit for judging a predicted value of utilization rate of the logic area 8, the unit for outputting a floor plan information 9, shown in FIG. 1, and the unit for producing equations of the average predicted value of a wiring length and others 15, the unit for computing the average predicted value of a wiring length and others 16, the first correcting unit 17, the unit for producing equations of the predicted value of the utilization rate 18 and the unit for computing the predicted value of the utilization rate 19, shown in FIG. 9 can be constituted with a CPU and a software (a program). This program can be recorded by a recording medium such as a hard disk, a flexible disc, a MO, a MT, a RAM, a CD-ROM or a DVD-ROM and others.

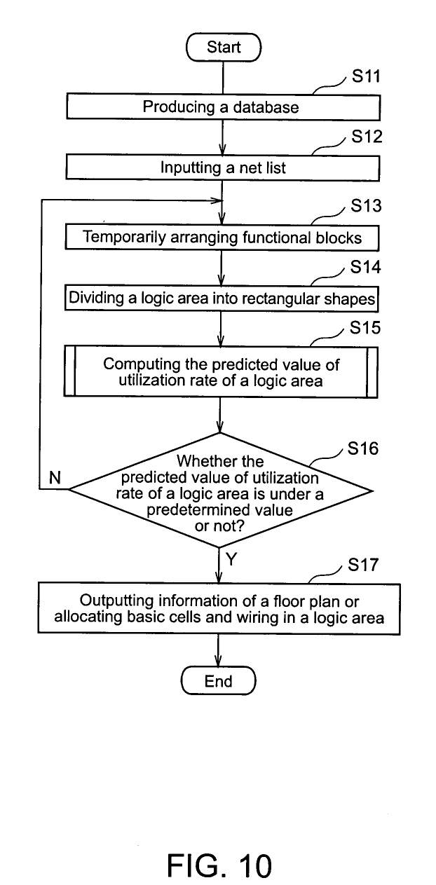

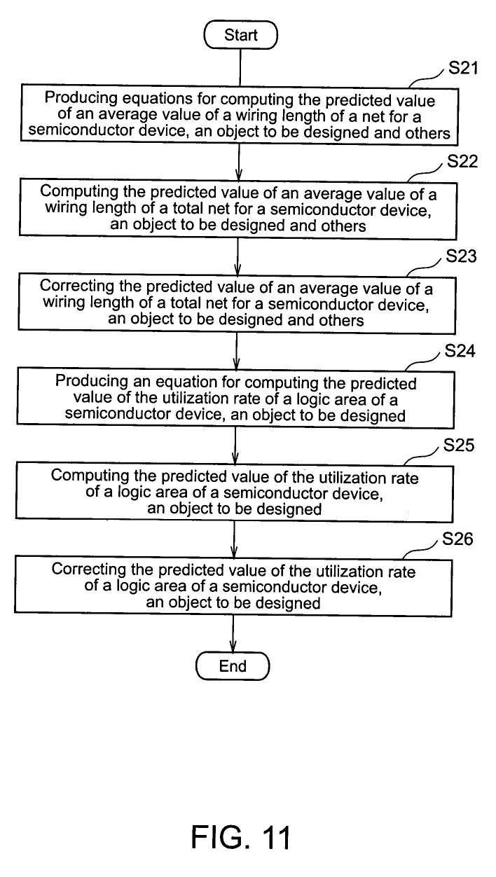

Next, the operation of the apparatus 1 for designing a floor plan of a semiconductor device is described referring to FIG. 1 and FIG. 9 to FIG. 11. FIG. 10 and FIG. 11 are flow charts showing the operation of an apparatus for designing a floor plan of the semiconductor device.

At first, the unit for producing the data base 13 in the unit for computing a predicted value of the utilization rate of the logic area 7 produces the data base using the net list of the semiconductor device designed in the past recorded in the second net list recording unit 11, data regarding basic cells arranged within the logic area of the semiconductor device designed in the past recorded in the unit for recording a basic cell information 12, data regarding basic cells to probably arranged within the logic area of the semiconductor device (step S11). As mentioned before, the data base produced by the unit for producing data base 13 in the unit for computing a predicted value of the utilization rate of the logic area 7 includes (i) information regarding basic cells arranged within the logic area of the semiconductor device designed in the past, (ii) information regarding the net list of the semiconductor device designed in the past, (iii) information regarding the wiring length of the semiconductor device designed in the past, (iv) information regarding utilization rate of the logic area of the semiconductor device designed in the past and (v) information regarding basic cells to probably be arranged within the logic area of the semiconductor device. The data base recording unit 14 records the database produced by the data base production unit 13.

Next, a user inputs the net list of the semiconductor device from the input unit 2, and the first net list recording unit 4 receives the inputted net list and records it (step S12). Here, the first net list recording unit 4 may receive and record a net list outputted from other CAD equipment, a CAD software and others in stead of receiving the net list inputted from the input unit 2.

Furthermore, a user inputs information identifying locations where functional blocks are temporarily arranged, from the input unit 2 and the unit for temporarily arranging functional blocks 5 temporarily arranges functional blocks at the location designated by a user (step S13).

The unit for temporarily arranging functional blocks 5 makes the display unit 3 display a layout of a semiconductor device where functional blocks are temporarily arranged such that a user can instruct change of arrangement of functional blocks with viewing a layout of the semiconductor device displayed by the display unit 3.

Next, the unit for dividing logic area 6 divides the logic area into a plurality of rectangle areas (step S14).

Next, the unit for computing a predicted value of the utilization rate of the logic area 7 computes a predicted value of the utilization rate of the logic area (step S15).

FIG. 11 is a flow chart, which shows a content of the step S15 of FIG. 10. When a step in FIG. 11 is started, the unit for producing equations of the average predicted value of the wiring length and others 15 in the unit for computing a predicted value of the utilization rate of the logic area 7 refers to database recorded in the database recording unit 14 and produces:

(m) an equation for computing the predicted value of an average value of the wiring length of the total nets for the semiconductor device in response to the number of layers of all usable wiring layers;

(n) an equation for computing the gradient of the graph where the number of connecting pins is along the abscissa and the predicted value of an average value of wiring lengths of nets for every number of connecting pins along the ordinate axis, in response to the number of layers of all usable wiring layers; and

(o) an equation for computing the predicted value of an average value of the wiring length of the net of which the number of connecting pins within the nets of the semiconductor device is two “2”, in response to the number of layers of all usable wiring layers (step S21).

According to the present embodiment, the unit for producing equations of the predicted value of an average value of a wiring length and others 15, produces the above-mentioned equations (m),(n) and (o) by a regression analysis.

The unit for producing equations of the predicted value of an average value of a wiring length and others 15, produces the following, for example, as an equation for computing an equation for computing the predicted value (here, it is referred to as Y1) of an average value of the wiring length of all nets, in response to the number of layers of all usable wiring layers;

Equation 2

Y1=a₁+b₁A+c₁B+d₁C+e₁D+f₁E+g₁F+h₁G+i₁H (2)

wherein:

A: a variable based on information of the size of gates (the total number of gates) of the semiconductor device;

B: a variable based on information showing the relationship between the size of basic cells arranged in the semiconductor device and the number of pins;

C: the number (a variable) of connection pins where a ratio of the number of accumulated nets to the number of all nets surpasses a predetermined value, when all nets of the semiconductor device are arrayed from a net having a small number of connection pins to a net having a large number of connection pins and accumulated from a net having a small number of connection pins;

D: a variables based on information showing a rate of the number of pins connected to a single net;

E: a ratio (a variable) of the net of which the number of connection pins is “2” to nets;

F: a gradient (a variable) of a straight line connecting the point of the number of connection pins, two “2” to the point of the number of connection pins where a ratio of the number of accumulated nets to the number of all nets surpasses a predetermined value, in a graph where the number of connection pins is along the abscissa and a ratio of the number of accumulated nets to the number of all nets is along the ordinate when all nets are arrayed from a net having the small number of connection pins to a net having the large number of connection pins and accumulated from a net having the small number of connection pins;

G: a variable based on information showing the relationship between the number of nets and the number of pins with respect to nets; and

H: a variable based on information showing the relationship between the size of basic cells arranged in the semiconductor device and the number of nets.

In addition, a₁, b₁, c₁, d₁, e₁, f₁, g₁, h₁ and i₁ are coefficients obtained by a regression analysis, for example.

In addition, the unit for producing equations of the average predicted value of a wiring length and others 15, produces the following, for example, as an equation for computing the gradient (referred to as Y5 here) of the graph where the number of connecting pins is along the abscissa and the predicted value of an average value of wiring lengths of nets for every number of connecting pins along the ordinate with respect to all nets of the semiconductor device at the predetermined wiring layer;

Equation 3

Y5=a₂+b₂B+c₂C+d₂D+e₂F+f₂F+g₂G+h₂H+i₂xY1. (3)

Here, a₂, b₂, c₂, d₂, e₂, f₂, g₂, h₂ and i₂ are coefficients obtained by a regression analysis, for example.

Furthermore, the unit for producing equations of the average predicted value of a wiring length and others 15, produces the following, for example, as a predicted value of an averaged value of wiring lengths of nets of which the number of connecting pins within the net of the semiconductor device is two “2”;

Equation 4

Y7=a₃+b₃B+c₃C+d₃E+e₃F+f₃F+g₃G+h₃Y5+i₃J1 (4)

Here, J1: a variable in response to the numbers of layers of aluminum wiring layers. In addition, for example, a₃, b₃, c₃, d₃, e₃, f₃, g₃, h₃ and i₃ are coefficients obtained by a regression analysis.

Next, the unit for computing the predicted value of an average value of a wiring length and others 16 in the unit for computing a predicted value of the utilization rate of the logic area 7, computes the following by using a net list of a semiconductor device recorded in the first net list recording unit 4 (see FIG. 1) and the equations (2) to (4):

(p) a predicted value of an average value of wiring lengths of all nets of a semiconductor in a predetermined wiring layer,

(q) a gradient in a graph where the numbers of connecting pins is along the abscissa and an predicted value of an averaged value of wiring lengths of nets for every number of connecting pins along the ordinate; and

(r) a predicted value of an averaged value of wiring lengths of nets of which the number of connecting pins, is two “2” (step S22).

Next, the first correcting unit 17 in the unit for computing a predicted value of the utilization rate of the logic area 7 corrects the following computed by the unit for computing the predicted value of an average value of a wiring length and others 16 in response to a configuration of a rectangular area of the semiconductor device:

(p) a predicted value of an average value of wiring lengths of all nets of the semiconductor in a predetermined wiring layer;

(q) a gradient of a graph where the numbers of connecting pins is along the abscissa and an predicted value of an averaged value of wiring lengths of nets for every number of connecting pins along the ordinate; and

(r) a predicted value of an average value of wiring lengths of nets of which the number of connecting pins, is two “2” (step S23).

Next, the unit for producing equations of the predicted value of the utilization rate 18 in the unit for computing a predicted value of the utilization rate of the logic area 7 refers to the data base recorded in the data base recording unit 14, and produces equations for computing the predicted value of the utilization rate of the logic area of the semiconductor device by using the above-mentioned values of (p) to ((r) computed by the unit for computing the average predicted value of a wiring length and others 16 (step S24). In the present embodiment, it is assumed that the unit for producing equations of the predicted value of the utilization rate 18 produces the predicted value of the utilization rate of the logic area of the semiconductor device by a regression analysis.

The unit for producing an equation of the predicted value (referred to as Y3) of the utilization rate 18 in the unit for computing a predicted value of the utilization rate of the logic area 7 produces the following, for example, as a predicted value of the utilization rate of the logic area of the semiconductor in a predetermined wiring layer:

Equation 5

Y3=a₄+b₄A+c₄B+d₄C+e₄D+f₄E+g₄F+h₄G+i₄H+j₄Y1+k₄Y5+l₄Y7 (5)

Here, a₄, b₄, c₄, d₄, e₄, f₄, g₄, h₄, i₄, j₄, k₄ and l₄ are coefficients obtained by a regression analysis, for example.

Next, the unit for computing the predicted value of the utilization rate 19 in the unit for computing a predicted value of the utilization rate of the logic area 7 computes the predicted value of the utilization rate of the logic area of the semiconductor device by using the net list of the semiconductor device stored in the first net list recording unit 4 (see FIG. 1) and the equation (5) (step S25).

Next, the second correcting unit 20 in the unit for computing a predicted value of the utilization rate of the logic area 7 corrects the predicted value of the utilization rate of the logic area of the semiconductor device computed by the unit for computing the predicted value of the utilization rate 19 in response to a configuration of a rectangular area of the semiconductor device (step S26).

In this way, the corrected predicted value of the utilization rate of the logic area of the semiconductor device is outputted to the unit for judging a predicted value of the utilization rate of the logic area 8 (see FIG. 1).

Referring to FIG. 10 again, the unit for judging a predicted value of the utilization rate of the logic area 8 judges whether the predicted value (the corrected value) of the utilization rate of the logic area of the semiconductor device is under a predetermined value or not. Then, if the unit for judging a predicted value of the utilization rate of the logic area 8 judges that the predicted value (the corrected value) of the utilization rate of the logic area of the semiconductor device is not under a predetermined value, it returns the process to the step 13. If it judges that the predicted value is under a predetermined value, it transfers the process to the step 17 (step S16).

If the unit for judging a predicted value of the utilization rate of the logic area 8 judges that the predicted value (the corrected value) of the utilization rate of the logic area of the semiconductor device is not under a predestined value (step S16), the unit for temporarily arranging functional blocks 5 makes the display unit 3 display a message so as to promote a user (a designer of the semiconductor device) to temporarily arrange functional blocks (step S13).

Thus, the reason why the process is returned to step 13 when the predicted value (the corrected value) of the utilization rate of the logic area of the semiconductor device is not under a predetermined value, is that the space for arranging aluminum wiring within the logic area of the semiconductor device is small and arrangement of the aluminum wiring is difficult when the predicted value (the corrected value) of the utilization rate of the logic area of the semiconductor device is over a predetermined value.

On the other hand, if the unit for judging a predicted value of the utilization rate of the logic area 8 judges that the predicted value (the corrected value) of the utilization rate of the logic area of the semiconductor device is under a predetermined value (step S16), the unit for outputting floor plan information 9, arranges basic cells, and wiring connecting basic cells, wiring connecting the basic cell to a functional block and wiring connecting functional blocks within the logic area in the semiconductor device or outputs floor plan information for arranging (step S17).

As discussed above, the apparatus for designing a floor plan of the semiconductor device 1 produces data base based on data regarding basic cells arranged in the logic area of the semiconductor device designed in the past, computes the predicted value of the utilization rate of the logic area of the semiconductor device based on this data base temporarily arranges functional blocks again when the predicted value of the utilization rate of the logic area of the semiconductor device is not under a predetermined value, and arranges basic cells and wiring within the logic area of the semiconductor device when the predicted value of the utilization rate of the logic area of the semiconductor device is under a predetermined value. Therefore, efficiency of designing the semiconductor device can be improved and the time of designing the semiconductor device can be shortened.

According to the present invention, it is possible to shorten design time of a semiconductor device as mentioned above.

What is claimed is:

1. A method for designing a semiconductor device comprising;
receiving a net list of a semiconductor device;
temporarily locating a plurality of functional blocks within a layout area of the semiconductor device;
dividing a logic area of the semiconductor device into a plurality of rectangular areas;
computing a predicted value of a utilization rate of the logic area and a predicted value of a wiring length of the semiconductor device based on a data base regarding a semiconductor device designed previously and the semiconductor device and the net list of the semiconductor device;
locating, dividing and computing when the predicted value of the utilization rate of the logic area of the semiconductor device does not satisfy a predetermined condition;
outputting floor plan information for allocating the plurality of functional blocks basic cells and wiring within the logic area of the semiconductor device when the predicted value of the utilization rate of the logic area satisfies the predetermined condition; and
outputting the predicted value of the wiring length of the semiconductor device.

2. The method of designing a semiconductor device claimed in claim 1 further comprising:
producing the data base including information regarding a basic cell located in a logic area of the semiconductor device designed previously, information regarding a net list of the semiconductor device designed previously, information regarding a wiring length of the semiconductor device designed previously, information regarding a utilization rate of the logic area of the semiconductor device designed previously, or information regarding the basic cell possibly located in the logic area of the semiconductor device.

3. The method of designing a semiconductor device claimed in claim 2, wherein, the information regarding the basic cell located in the logic area of the semiconductor device designed previously or the information regarding the basic cell possibly located in the logic area of the semiconductor device includes information regarding a number of pins held by the basic cell, information regarding a number of nets connected to the basic cell or information regarding a kind of basic cell.

4. The method of designing a semiconductor device claimed in claim 2, wherein the information regarding the basic cell located in the logic area of the semiconductor device designed previously includes a total number of gates, information regarding a relationship between the net list and the number of pins, which is obtained by classifying all nets in terms of a connection pin number.

5 The method of designing a semiconductor device claimed in claim 2, wherein, information regarding the wiring length of the semiconductor device designed previously includes information regarding a total wiring length of the net list when a number of layers of aluminum wiring layers are predetermined or information regarding a relationship between a number of pins and wiring length, obtained by classifying all nets in terms of a connection pin number.

6. The method of designing a semiconductor device claimed in claim 2, wherein information regarding the utilization rate of the logic area of the semiconductor device designed previously includes a maximum value of the utilization rate in case when a number of layers of aluminum wiring layers is a predetermined number and a configuration of the logic area is a square.

7. The method of designing a semiconductor device claimed in claim 2 further comprising:
producing a first equation for computing a predicted value of an average value of the wiring length of a total number of nets for the semiconductor device a second equation for computing a gradient in a graph where a number of connecting pins is along the abscissa and a predicted value of an average value of the wiring length of a net for every number of connecting pins along the ordinate, or a third equation for computing a predicted value of an average value of the wiring length of the net of which the number of connecting pins within the net of the semiconductor device is two “2”, based on the data base, in response to a number of layers of aluminum wiring layers of the semiconductor device;
using the first to the third equations and the net list of the semiconductor device and computing; the predicted value of an average value of the wiring length of the total number of nets of the semiconductor device; the gradient in the graph where the number of connecting pins is along the abscissa and the predicted value of the average value of the wiring length of a net for every number of connecting pins along the ordinate with respect to the total number of nets of the semiconductor device; or the predicted value of the average value of the wiring length of a net of which the number of connecting pins within the net of the semiconductor device is two “2”, in response to the number of layers of aluminum wiring layers of the semiconductor device;
a step (j) correcting; the predicted value of the average value of the wiring length of the total number of nets of the semiconductor; the gradient in the graph where the number of connecting pins is along the abscissa and the predicted value of the average value of the wiring length of the net for every number of connecting pins along the ordinate with respect to the total nets of the semiconductor device; or the predicted value of the average value of the wiring length of the net of which the number of connecting pins within the net of the semiconductor device is two “2”, that were computed in the step(i), in response to the configuration of the rectangular area,
a step (k) producing a fourth equation for computing the predicted value of the utilization rate of the logic area of the semiconductor device based on;
the data base;
the predicted value of the average value of the wiring length of the total number of nets of the semiconductor device;
the gradient in the graph where the number of connecting pins is along the abscissa and the predicted value of the average value of the wiring length of the net for every number of connecting pins along the ordinate with respect to the total number of nets of the semiconductor device;
or the predicted value of the average value of the wiring length of the net of which the number of connecting pins within the net of the semiconductor device is two “2”, that were computed in the step (i); and
the total number of nets of the semiconductor device in response to the number of layers of aluminum wiring layers of the semiconductor device;
a step (l) computing the predicted value of the utilization rate of the logic area of the semiconductor device based on the fourth equation, in response to the number of layers of aluminum wiring layers of the semiconductor device; and
a step (m) correcting the predicted value of the utilization rate of the logic area of the semiconductor device in response to the configuration of the rectangular area.

8. The method of designing a semiconductor device claimed in claim 7, further comprising producing the first to third equations by a regression analysis producing and the fourth equation by the regression analysis.

9. The semiconductor device having been designed by the method of designing a semiconductor device claimed in claim 1.

10. An apparatus for designing a semiconductor device comprising:
means for inputting a net list of a semiconductor device and information that designates an arranged location of a plurality of functional blocks, which are located within the semiconductor device;
means for recording the net list of the semiconductor device;
means for recording a data base with respect to a semiconductor device designed previously and the semiconductor device;
means for recording information with respect to a basic cell located within the semiconductor device designed previously and the basic cell possibly located in a logic area of the semiconductor device;
means for temporarily arranging the plurality of functional blocks, which temporarily arranges the plurality of functional blocks within a layout region of the semiconductor device, in response to information designating the arranged location;
means for dividing the logic area of a semiconductor device into a plurality of rectangular areas;
means for computing a predicted value of a utilization rate of the logic area, which computes a predicted value of a wiring length and the predicted value of the utilization rate of the logic area of the semiconductor device based on the data base and the net list of the semiconductor device;
a means for judging the predicted value of the utilization rate of the logic area, which judges whether the predicted value of the utilization rate of the logic area in the semiconductor device satisfies a predetermined condition or not, and promoting a user to input information designating new arranged location for the plurality of functional blocks located within the semiconductor device when the predicted value of the utilization rate of the logic area does not satisfies the predetermined condition;
means for outputting floor plan information, which outputs floor plan information for arranging the plurality of functional blocks, basic cells, and wiring within the logic area of the semiconductor device or arranges the plurality of functional blocks, basic cells, and wiring when the predicted value of the utilization rate of the logic area satisfies the predetermined condition;
means for outputting the predicted value of the wiring length, which outputs the predicted value of the wiring length of the semiconductor device; and
means for displaying the layout of the semiconductor device where the plurality of functional blocks is temporarily arranged by the means for temporarily arranging a plurality of functional blocks an image for promoting the user to input information designating new arranged location for the plurality of functional blocks located within the semiconductor device when the predicted value of the utilization rate of the logic area does not satisfy the predetermined condition; and/or the layout of the semiconductor device where the plurality of functional blocks, basic cells, and wiring are arranged by the means for outputting floor plan information.

11. The apparatus for designing a semiconductor device claimed in claim 10 further comprising:
means for recording a net list of a semiconductor device designed previously; and
means for producing the data base including information regarding a basic cell located within a logic area of a semiconductor device designed previously, information regarding the net list of the semiconductor device designed previously, information regarding a wiring length of the semiconductor device designed previously, information regarding a utilization rate of a logic area of the semiconductor device designed previously, and/or information regarding the basic cell to probably be arranged within the logic area of the semiconductor device based on the net list of the semiconductor device designed previously, information regarding the basic cell located within the logic area of the semiconductor device designed previously and the basic cell to probably be arranged within the logic area of the semiconductor device.

12. The apparatus for designing a semiconductor device claimed in claim 11, wherein the information regarding the basic cell located within the logic area of the semiconductor device designed previously or the information regarding a basic cell to probably be arranged within a logic area of the semiconductor device includes information regarding a numbers of pins included in the basic cell, information regarding a number of nets connected to the basic cell or information regarding a kind of basic cell.

13. The apparatus for designing a semiconductor device claimed in claim 11, wherein the information regarding the net list of the semiconductor device designed previously includes a total number of gates, information regarding a relationship between a number of pins and the net list, obtained by classifying all nets in terms of a connection pin number or information regarding a ratio of the number of nets to the number of pins.

14. The apparatus for designing a semiconductor device claimed in claim 11, wherein the information regarding the wiring length of the semiconductor device designed previously includes information regarding a total wiring length of the net list when a number of layers of aluminum wiring layers is a predetermined number or information regarding a relationship between the wiring length and a number of pins obtained by classifying all nets in terms of a connection pin number.

15. The apparatus for designing a semiconductor device claimed in claim 11, wherein the information regarding the utilization rate of the logic area of the semiconductor device designed previously includes a maximum value of the utilization rate when a number of layers of aluminum wiring layers is a predetermined number and a configuration of the logic area is a square.

16. The apparatus for designing a semiconductor device claimed in claim 11, wherein the means for computing the predicted value of the utilization rate of the logic area includes:
a unit for producing equations of the predicted value of an average value of the wiring length and others that produce; a first equation for computing a predicted value of an average value of a wiring length of a total number of nets for the semiconductor device; a second equation for computing a gradient in a graph where a number of connecting pins is along the abscissa and a predicted value of an average value of a wiring length of a net for every number of connecting pins along the ordinate; or a third equation for computing a predicted value of an average value of a wiring length of a net of which the number of connecting pins within the net of the semiconductor device is two “2”, based on the data base, in response to number of layers of aluminum wiring layers of the semiconductor device;
a unit for computing the predicted value of the average value of the wiring length and others that uses the first to the third equations and the net list of the semiconductor device and computes; the predicted value of the average value of the wiring length of the total number of nets of the semiconductor; the gradient in the graph where the number of connecting pins is along the abscissa and the predicted value of an average value of the wiring length of the net every for number of connecting pins along the ordinate with respect to the total nets of the semiconductor device; or the predicted value of the average value of the wiring length of the net of which the number of connecting pins within the net of the semiconductor device is two “2”, in response to the number of layers of aluminum wiring layers of the semiconductor device;
a first correcting unit that corrects; the predicted value of the average value of the wiring length of the total number of nets of the semiconductor device; the gradient in the graph where the number of connecting pins is along the abscissa and the predicted value of the average value of the wiring length of the net for every number of connecting pins along the ordinate with respect to the total number of nets of the semiconductor device; or the predicted value of the average value of the wiring length of the net of which the number of connecting pins within the net of the semiconductor device is two “2”, that were computed in the unit for computing the predicted value of the average value of the wiring length and others, in response to the configuration of the rectangular area,
a unit for producing an equation for computing the predicted value of the utilization rate that produces a fourth equation for computing the predicted value of the utilization rate of the logic area of the semiconductor device based on; the data base; the predicted value of the average value of the wiring length of the total number of nets of the semiconductor device; the gradient in the graph where the number of connecting pins is along the abscissa and the predicted value of the average value of the wiring length of the net for every number of connecting pins along the ordinate with respect to the total number of nets of the semiconductor device; or the predicted value of the average value of the wiring length of the net of which the number of connecting pins within the net of the semiconductor device is two “2”, that were computed in the unit for computing the predicted value of the average value of the wiring length and others, and the net list of the semiconductor device in response to the number of layers of aluminum wiring layers of the semiconductor device;
a unit for computing the predicted value of the utilization rate that computes the predicted value of the utilization rate of the logic area of the semiconductor device based on the fourth equation, in response to the number of layers of aluminum wiring layers of the semiconductor device; and
a second correcting unit that corrects the predicted value of the utilization rate of the logic area of the semiconductor device in response to the configuration of the rectangular area.

17. The apparatus for designing a semiconductor device claimed in claim 16, wherein the unit for producing equations of the predicted value of the average value of the wiring length and others produces the first to third equations by a regression analysis and the unit for producing the equation for computing the predicted value of the utilization rate produces the fourth equation by the regression analysis.

18. A program of designing a semiconductor device, making a CPU execute:
a step (a) receiving a net list of a semiconductor device;
a step (b) temporarily locating a plurality of functional blocks within a layout area of the semiconductor device;
a step (c) dividing a logic area of the semiconductor device, into a plurality of rectangular areas;
a step (d) computing a predicted value of a utilization rate of the logic area and a predicted value of a wiring length of the semiconductor device based on a data base regarding a semiconductor device designed previously and the semiconductor device and a net list of the semiconductor device;
a step (e) repeating the step (b) to the step (d) when the predicted value of the utilization rate of the logic area of the semiconductor device does not satisfy a predetermined condition;
a step (f) outputting floor plan information for allocating the plurality of functional blocks, basic cells and wiring within the logic area of the semiconductor device when the predicted value of the utilization rate of the logic area of the semiconductor device satisfies the predetermined condition; and
a step (g) outputting the predicted value of the wiring length of the semiconductor device.

19. The program of designing a semiconductor device claimed in claim 18, making a CPU execute a step for producing the data base including information regarding a basic cell located within a logic area of the semiconductor device designed previously, information regarding the net list of the semiconductor device designed previously, information regarding wiring length of a semiconductor device designed in the past, information regarding a utilization rate of the logic area of the semiconductor device designed previously, or information regarding a basic cell to probably be arranged within the logic area of the semiconductor device.

20. The program claimed in claim 19, wherein the information regarding the basic cell located within the logic area of the semiconductor device designed previously or the information regarding the basic cell to probably be arranged within the logic area of the semiconductor device includes information regarding a number of pins included in the basic cell, information regarding a number of nets connected to basic cell or information regarding a kind of basic cell.

21. The program claimed in claim 19, wherein the information regarding the net list of the semiconductor device designed previously includes a total number of gates, information regarding a relationship between a number of pins and the net list obtained by classifying all nets in terms of a connection pin number or information regarding a ratio of a number of nets to the numbers of pins.

22. The program claimed in claim 19, wherein the information regarding the wiring length of the semiconductor device designed previously includes information regarding a total wiring length of the net list when a number of layers of aluminum wiring layers is a predetermined number or information regarding a relationship between the wiring length and a number of pins obtained by classifying all nets in terms of a connection pin number.

23. The program claimed in claim 20, wherein the information regarding the utilization rate of the logic area of the semiconductor device designed previously, includes a maximum value of a rate of the utilization when the number of layers of aluminum wiring layers is a predetermined number and a configuration of the logic area is a square.

24. The program claimed in claim 19, wherein step (d) includes:
a step (h) producing a first equation for computing a predicted value of an average value of a wiring length of a total number of nets for the semiconductor device, a second equation for computing a gradient in a graph where a number of connecting pins is along the abscissa and a predicted value of an average value of a wiring length of a net for every number of connecting pins along the ordinate or a third equation for computing a predicted value of an average value of a wiring length of a net of which a number of connecting pins within a net of the semiconductor device is two “2”,based on the data base, in response to the number of layers of aluminum wiring layers of the semiconductor device;
a step (i) using the first to the third equations and the net list of the semiconductor device and computing, the predicted value of the average value of the wiring length of the total number of nets of the semiconductor device the gradient of the graph where the number of connecting pins is along the abscissa and the predicted value of the average value of the wiring length of the net for every number of connecting pins is along the ordinate with respect to the total number of nets of the semiconductor device; or the predicted value of the average value of the wiring length of the net of which the number of connecting pins within the net of the semiconductor device is two “2”, in response to the number of layers of aluminum wiring layers of the semiconductor device;
a step (j) correcting the predicted value of the average value of the wiring length of the total number of nets of the semiconductor device; the gradient in the graph where the number of connecting pins is along the abscissa and the predicted value of the average value of the wiring length of the net for every number of connecting pins is along the ordinate with respect to the total number of nets of the semiconductor device; or the predicted value of the average value of the wiring length of the net of which the number of connecting pins within the net of the semiconductor device is two “2”, that were computed in the step (i), in response to the configuration of the rectangular area;
a step (k) producing a fourth equation for computing a predicted value of the utilization rate of the logic area of the semiconductor device based on; the data base; the predicted value of the average value of the wiring length of the total number of nets of the semiconductor; the gradient in the graph where the number of connecting pins is along the abscissa and the predicted value of the average value of the wiring length of the net for every number of connecting pins is along the ordinate with respect to the total number of nets of the semiconductor device; or the predicted value of the average value of the wiring length of the net of which the number of connecting pins within the net of the semiconductor device is two “2” that were computed in the step (i), and the total nets of the semiconductor device in response to the number of layers of aluminum wiring layers of the semiconductor device;
a step (l) computing the predicted value of the utilization rate of the logic area of the semiconductor device, based on the fourth equation, in response to the number of layers of aluminum wiring layers of the semiconductor device; and
a step (m) correcting the predicted value of the utilizations rate of the logic area of the semiconductor device in response to the configuration of the rectangular area.

25. The program claimed in claim 24, wherein step (h) produces the first to third equations by regression analysis and step (l) produces the fourth equation by regression analysis.
